(19) United States
(12) Patent Application Publication
(10) Pub. No.: US 2015/0315017 A1
(43) Pub. Date: Nov. 5, 2015

(54) REGENERATION OF SPENT HYDRIDE FUEL

(71) Applicant: Cella Acquisition Limited, Didcot, Oxfordshire (GB)

(72) Inventor: Gerard Sean McGRADY, Merritt Island, FL (US)

(73) Assignee: Cella Acquisition Limited, Didcot, Oxfordshire (GB)

(21) Appl. No.: 14/440,293

(22) PCT Filed: Oct. 31, 2013
(86) PCT No.: PCT/GB13/52848

§ 371 Date: May 1, 2015

Related U.S. Application Data
(60) Provisional application No. 61/721,925, filed on Nov. 2, 2012.

(51) Int. Cl. C01B 3/04; C01B 35/14; H01M 8/04

(52) U.S. Cl. CPC C01B 3/04; H01M 8/04097; C01B 35/146

(57) ABSTRACT

A process for regenerating spent hydride fuel comprises the steps of (1) generating hydrazine from a plasma; for example generating a solution of hydrazine in liquid ammonia using a plasma generated in a glow discharge cell, (2) contacting the spent hydride fuel with said hydrazine and (3) thereafter separating a regenerated hydride fuel therefrom. The process is widely applicable in regenerating spent hydride transportation fuels which are used to power for example a fuel cell or an internal combustion engine. It is especially useful in regenerating spent ammonia borane fuels such as those arising from the dehydrogenation of ammonia borane/polymer composite fuels.

This invention relates to a process for regenerating spent hydride fuel using hydrazine which has been generated using plasma; for example electrochemically from ammonia in a glow discharge cell.

Hydrogen gas holds the potential to provide mankind with a clean, reliable and affordable energy carrier. For example, it can be easily produced from water by electrolysis using renewable energy sources and then converted back into water in an electrochemical or combustion process, releasing over 3 times more chemical energy than conventional fossil fuels on a mass-by-mass basis. Moreover, clean and renewable generation of hydrogen in this way mitigates some of the severe problems associated with the burning of fossil fuels, such as the release of CO₂ and other greenhouse gases, and the emission of other hazardous pollutants like diesel exhaust particulates.

However, when it comes to using hydrogen gas as a transportation fuel several major scientific and technical challenges exist among which the safe and efficient storage of the hydrogen on-board a vehicle is widely recognized as the most formidable. Consequently, many materials have been considered in the search for potential alternatives including simple metal hydrides and those complex hydrides derived therefrom such as lanthanum nickel hydride, LaNi₅H₆, sodium aluminium hydride, NaAlH₄, lithium borohydride LiBH₄ and magnesium borohydride, Mg(BH₄)₂. However, these either release insufficient quantities of hydrogen or else are not easily regenerable from their spent form by rehydrogenation. Zeolites, metalorganic frameworks (MOFs) and other porous carbon-based materials have also been shown to physically adsorb large amounts of hydrogen gas, but these materials struggle to retain it at temperatures above that of the liquid nitrogen generally used to charge them (−196° C.).

In the light of these drawbacks, recent efforts have focused on the development of chemical hydrogen storage materials, which release appreciable amounts of H₂ at low-to-moderate temperatures. However, such materials cannot be regenerated easily and directly with hydrogen gas, but instead require chemical reprocessing. Of these, ammonia borane (NH₃BH₃; AB) is the most promising material under investigation as it contains a high hydrogen content (19.6% by weight) which is released in three stages according to the following stoichiometric equations:

NH₃BH₃→NH₂BH₂+H₂

NH₂BH₂→NHBH+H₂

NHBH→NB+H₂

The high-temperatures required to activate reaction 3 however mean that in general practice only reactions 1 and 2 are used to generate hydrogen for use in fuel cells or other devices. Since each of these stages is an exothermic process it is recognised that regeneration of any spent fuel will require off-board chemical processing.

Whilst the dehydrogenation products generated in reactions 1 and 2 can generically be described in the stoichiometric forms written above, spent ammonia borane fuel in practice exists as a complex mixture of these components in polymeric form. For example, both (NH₂BH₂)ₓ or (poly)aminoborane (PAB), and (NHBH)ₓ or poly(imino)borane (PIB), consist of a range of chain polymers of different molecular weights, each with varying degrees of cross-linking and ,in many cases, a high proportion of cyclization. Such spent ammonium boranes fuels thus comprise amorphous materials generally referred to as (poly)borazylenes (PB).

The complex and intractable nature of PB makes regeneration of spent ammonia borane fuel a challenging proposition. To date, only a handful of successful regeneration methods have been identified. For example, Ramachandran and Gagare (Inorg. Chem. 2007, 46 7810) have reported that the product obtained from the metal-mediated solvolysis of ammonia borane ([NH₄][B(OMe)₄]) can be readily converted back to the starting material at ambient temperature through reaction with NH₄Cl and LiAIH₄. However, this method only recovers about 81% of the starting material, making the approach unattractive for large-scale technological application. Moreover, the formation of a product containing a strong B—O bond limits the efficiency of the process as this will need to be reduced to reform ammonia borane.

Hausdorf, Baitalow, Wolf and Mertens (Int. J. Hydrogen Energy 2008, 33 608) have developed a method of recycling which involves in a first step digesting the material in HCl/AlCl₃ superacid mixture to form BCl₃ and NH₄Cl. An analogous approach has also adopted by Sneddon (http://www.hydrogen.energy.gov/pdfs/review07/st_{—}27_sneddon.pdf), using an HBr/AlBr₃ mixture. The challenge associated with this route lies in the subsequent dehalogenation of the boron trihalide intermediate, which typically requires heating to high temperatures (>600° C.)

In light of these problems, Sutton et al (Science 2011, 331 1426 and US Patent Application 2010/0272622) have explored the potential of hydrazine (N₂H₄) as a reducing agent to regenerate ammonia borane from PB. The solubility of PB in polar solvents prompted these researchers to carry out initial experiments in THF solvent at room temperature. Indeed, this approach resulted in upgrading of the spent material to materials that contained only —BH₃ moieties which upon heating converted to ammonia borane with high selectivity. This process however suffers from the drawback that hydrazine is a toxic and highly unstable material meaning that its manufacture and manipulation on an industrial scale has hitherto been limited to the relatively small amounts required to service its use as a rocket propellant.

We have now developed an improved regeneration process which relies on contacting the spent hydride fuel with hydrazine generated using a plasma source for example in situ from liquid ammonia in an electrolytic cell. Our latter approach is based on an observation by Hickling and Newns over half a century ago (Proc. Chem. Soc. London 1959, 272 and 368; ibid 1961 5177 and 5186) that when liquid ammonia is subjected to glow discharge electrolysis significant quantities of hydrazine can be generated in a controlled manner. However Hickling and Newns make no mention of using the hydrazine in situ but rather suggest that the hydrazine containing liquid ammonia so obtained should be worked up into the two separate components

Thus according to the present invention there is provided a process for regenerating a spent hydride fuel which comprises the steps of (1) generating hydrazine from a plasma, (2) contacting the spent hydride fuel with said hydrazine and (3) thereafter separating a regenerated hydride fuel therefrom.

In one embodiment of this invention the hydrazine is generated from a plasma of ionised gaseous hydrogen and nitrogen generated using microwaves, an electron beam or electron cyclotron resonance. Typically such ionisation processes are carried out at a temperature in the range 100 to 500° C. with an electron temperature in excess of 14,000° K. to generate a mixture of hydrazine and ammonia. Suitably they are carried out in the presence of an iron or molybdenum catalyst to improve the yield of hydrazine relative to ammonia. Alternatively, or in addition, yields of hydrazine can further be improved by first ionising the nitrogen and then subsequently adding the hydrogen in an after-glow region. In one embodiment of these processes the hydrazine generated can be captured in a solvent, for example ammonia which can the function as the medium in which step (b) is carried out.

In another embodiment of the invention the plasma is generated in a glow discharge cell or via a silent electric discharge. For example, there is provided a process for regenerating a spent hydride fuel which comprises the steps of (1) generating a solution of hydrazine in liquid ammonia in a glow discharge cell, (2) contacting the spent hydride fuel with said solution and (3) thereafter separating a regenerated hydride fuel therefrom.

Preferably the spent hydride fuel is one derived from the dehydrogenation of ammonia borane or a metal amidoborane selected from one or more of lithium amidoborane, sodium amidoborane, magnesium amidoborane, calcium amidoborane, aluminium amidoborane. More preferably the spent hydride fuel is derived from a spent hydride/polymer composite fuel especially an ammonia borane/polymer composite as descried in for example WO2012/017218.

Where a glow discharge cell used in step (a) of the process, it is suitably an electrolytic cell in which, in one conventional arrangement, a cathode is immersed in an electrolyte contained within the cell and an anode arranged in the headspace above. Specifically, in this embodiment of the present invention, the cathode is immersed in liquid ammonia and the anode in the ammonia vapour-containing head space. In such an arrangement, and at relatively high voltages (up to 800 V), low temperatures and therefore low ammonia partial pressures in the headspace, a plasma discharge occurs and produces a range of high-energy ions in the vapour above the liquid surface. It is believed that these then accelerate away from the positively charged anode towards the cathode, entering the liquid with high velocity and causing collisions that produce significant concentrations of the NH₂_{^{.}} radical; the dimerization of which results in the formation of hydrazine according to the following equations:

NH₃⁺+NH₃→NH₄⁺+NH₂

NH₂++NH₃→NH₃⁺+NH₂

NH₂_{^{.}}+NH₂_{^{.}}→N₂H₄

Typically the liquid ammonia used in such a cell has dissolved therein an electrolyte preferably an ammonium or amide salt to improve its conductivity. In this conventional arrangement, the temperature should be less than −50° C. and the associated ammonia partial pressure in the headspace less than 10 KPa in order to strike a plasma discharge which is stable.

A similar effect can be obtained if the anode is also immersed in the liquid ammonia, but the cell is operated at a very high voltage (e.g. 400 to 800 V) and temperatures of less than −50° C. In such a voltage regime, plasma forms around the submerged anode enabling hydrazine to be produced rapidly and in significant concentrations. Such a variant on the conventional approach, sometimes called contact glow discharge electrolysis, is also within the scope of our invention and is a preferred embodiment.

Thereafter in step (2) of the process the hydrazine obtained in step (1) is caused to react with the spent hydride fuel at a temperature from 40 to 80° C. preferably from 55 to 65° C.

The process of the present invention may be carried out in single batch or in continuous batch mode. In a typical batch operation using a glow discharge cell, a pressure reaction vessel equipped with temperature and pressure control and an internal electrode is charged with spent ammonia borane fuel and ammonium nitrate electrolyte. Immediately thereafter, ammonia gas is added through a gas inlet. The temperature of the vessel is then cooled to −60° C. so that the ammonia condenses and develops the required vapour pressure (10 KPa) within the vessel. The exact amount of liquid ammonia may be controlled by weighing the vessel or by filling it to a predetermined level. A potential difference is next applied between the outer wall of the vessel (cathode) and an internal electrode (anode), and a current is passed between these electrodes such that the combination of current and potential difference is appropriate to establish a glow discharge in the vicinity of the anode. This leads to the generation of hydrazine as explained above which in turn dissolves in the liquid ammonia up to a limiting concentration of ca. 2 M. Hydrogen gas co-generated as a by-product of this process can be vented and captured through a low temperature vapour condenser attached to the vessel, which strips out any ammonia and hydrazine contained therein and returns it to the cell. Thereafter, it is observed that when the content of the reaction vessel are warmed to a temperature of 60° C., the hydrazine/ammonia mixture thus generated reacts with the spent ammonia borane fuel to regenerate ammonia borane. The regenerated ammonia borane can then be separated from the ammonia/hydrazine mixture in the reaction vessel by switching off the low temperature condenser and raising the temperature of the reaction vessel, then transferring the ammonia and residual hydrazine vapours into a storage vessel or directly into a second reaction vessel charged with dehydrogenated ammonia borane, at the same time venting any nitrogen gas generated from the reaction of hydrazine with the spent fuel. In this way, regenerated ammonia borane may be directly recovered as a solid from the reaction vessel, or sublimed onto the low temperature condenser to improve its purity if necessary by reducing the pressure inside the vessel and raising its temperature.

In a variation of the process of the present invention, the amount of current passed during the electrolysis stage is controlled to generate an amount of hydrazine just sufficient to regenerate all of the dehydrogenated ammonia borane introduced into the reactor. In this case, only ammonia needs to be transferred to a storage vessel upon completion of the reaction. This avoids the problems associated with the manipulation of hydrazine.

In one preferred variation of the procedure, the spent ammonia borane fuel introduced into the reaction vessel is one which has been generated from an ammonia borane/polymer composite, for example that disclosed in WO2012/017218 referred to above. If the polymer fraction is soluble in the liquid ammonia, the composite may be reconstituted in a single stage by regenerating the ammonia borane and then raising the temperature (or reducing the pressure) of the vessel and rapidly venting the liquid ammonia to leave behind a homogeneous, mono-dispersed ammonia borane/polymer composite. If the polymer is insoluble in the liquid ammonia, then the polymer may be removed by dissolution in a solvent before introduction of the treated spent fuel into the reaction vessel. Alternatively, the regenerated ammonia borane may be recovered by sublimation or solvent extraction, and the ammonia borane/polymer composite may be reconstituted by conventional methods.

In a continuous batch mode operation of the process of the invention, liquid ammonia and ammonium nitrate electrolyte are for example passed into an electrolysis chamber provided with one or more electrodes, where conventional or contact glow discharge electrolysis can be conducted at a predetermined rate and at −60° C. to generate the hydrazine/liquid ammonia mixture. This mixture is then transferred to a second chamber where it is warmed and comes into contact with the spent ammonia borane fuel at a temperature of 60° C. The contents of the second reactor are then held at a temperature as described above for a length of time sufficient to completely regenerate the ammonia borane Thereafter the solution of hydrazine and regenerated ammonia borane in liquid ammonia is passed to a third chamber, where the temperature is raised further and the pressure reduced so that any residual hydrazine and/or ammonia evaporates into a storage chamber (or is recycled directly to the electrolysis chamber), and regenerated ammonia borane is recovered as a solid. During this procedure, the hydrogen and nitrogen gases are removed from the electrolysis and reaction chambers using low temperature condensers, and subsequent batches of spent ammonia borane fuel are fed into the reaction chamber along with recycled and freshly generated hydrazine/ammonia mixtures. Spent ammonia borane/polymer composites can be treated in a manner analogous to that described above for a batch operation.

1. A process for regenerating spent hydride fuel characterised by the steps of (1) generating hydrazine from a plasma, (2) contacting the spent hydride fuel with said hydrazine and (3) thereafter separating a regenerated hydride fuel therefrom

2. A process as claimed in claim 1 wherein step (1) comprises generating a solution of hydrazine in liquid ammonia in a glow discharge cell.

3. A process as claimed in claim 2 wherein the spent hydride fuel is spent ammonia borane.

4. A process as claimed in claim 2 wherein the spent hydride fuel is derived from one or more of lithium amidoborane, sodium amidoborane, magnesium amidoborane, calcium amidoborane, aluminium amidoborane.

5. A process according to claim 2 wherein the glow discharge cell operates using conventional glow discharge.

6. A process according to claim 2 wherein the glow discharge cell operates using contact glow discharge.

7. A process as claimed in claim 2 wherein the liquid ammonia further comprises an ammonium salt or an amide salt.

8. A process as claimed in claim 2 wherein the voltage applied across the cell is from 400 to 800 volts.

9. A process as claimed in claim 2 wherein step (1) is carried out at less than −50° C.

10. A process as claimed in claim 2 wherein step (2) is carried out at a temperature from 40 to 80° C.

11. A process as claimed in claim 2 operated in either batch mode or continuous batch mode.

12. A process as claimed in claim 1 in which the spent hydride fuel is a spent hydride/polymer composite fuel.

13. A process as claimed in claim 12 wherein the spent hydride/polymer composite fuel is a spent ammonia borane/polymer composite fuel.

14. A process as claimed in claim 1 wherein the spent ammonia borane fuel is separated into spent ammonia borane and polymer by sublimation after being contacted with the solution.

15. A process as claimed in claim 1 wherein the spent ammonia borane fuel is separated into spent ammonia borane and polymer by dissolution of one or other component in a solvent before being contacted with the solution.

16. A process as claimed in claim 1 wherein the plasma is generated using microwaves, an electron beam, electron cyclotron resonance or a silent electric discharge.

17. A process as claimed in claim 1 carried out in the presence of an iron or molybdenum catalyst.

18. Use of a regenerated hydride fuel produced by a process of claim 1 as a fuel to power a fuel cell or an internal combustion engine.
